(19) United States
(12) Patent Application Publication
(10) Pub. No.: US 2010/0090956 A1
(43) Pub. Date: Apr. 15, 2010

(54) OPTICAL MOUSE

(75) Inventors: CHIN-LIN LIU, TAICHUNG COUNTY (TW); QUN QIAN, TAIPEI COUNTY (TW)

Correspondence Address: ROSENBERG, KLEIN & LEE, 3458 ELLICOTT CENTER DRIVE-SUITE 101, ELLICOTT CITY, MD, 21043, US

(73) Assignee: ELAN MICROELECTRONICS CORPORATION, HSINCHU (TW)

(21) Appl. No.: 12/574,803

(22) Filed: Oct. 7, 2009

(30) Foreign Application Priority Data
Oct. 9, 2008 (TW) 097139044

(51) Int. Cl. G09G 5/08

(52) U.S. Cl. 345/166

(57) ABSTRACT

Well-designed absolutely fixing mechanisms are provided for optical mice to avoid loose engagement between the optical components and base plate in an optical mouse, and eliminate shifting and out-of-focus of the light path in the optical mouse, thereby improving performance of the optical mouse.

### FIELD OF THE INVENTION

The present invention is related generally to an optical mouse and, more particularly, to a light path stabilizing mechanism for optical mice.

### BACKGROUND OF THE INVENTION

Since the advent of twenty-first century, optical mice have replaced conventional roller ball mice in a wide range of applications owing to their advantages of flexibility in use and durability. FIG. 1 is a simplified diagram showing the parts of an optical mouse. To facilitate mass production and assembly, the optical parts of an optical mouse are manufactured separately, and during assembly, a printed circuit board (PCB) 16 with an optical sensor chip 14 and a light source device 12 soldered thereon is assembled to an optical lens 18, which is in turn assembled to a base plate 19 with a fool-proof structure 194 and a recess 192 on the base plate 19, and then a light source mount 10 is fixed to the PCB 16 in a tight fit, thereby completing an optical mouse.

FIG. 2 is a side view of the optical mouse shown in FIG. 1 to depict the light path thereof. The light source device 12 is generally a red light emitting diode (LED), and the light emitted from the light source device 12 is refracted and reflected by the optical lens 18, and then passes through an opening 196 to impinge obliquely on a plane where it is reflected back to the optical lens 18 to be imaged onto the optical sensor chip 14. Different features and roughness of the desktop surface will result in different energy intensity of the reflected light to exhibit corresponding features in the image. When the optical mouse is moved, continuous patterns will be obtained in the optical sensor chip 14 which then, according to difference in positions of features of the continuous images, compares and analyzes each of the images to determine the moving direction and displacement of the optical mouse. In other words, imaging quality is a key factor that dominates performance of the optical mouse. Hence, when loose engagement or misalignment between individual parts of the optical mouse occurs, light reflected from the desktop surface will fail to follow the correct light path and travel to the optical sensor chip 14. Consequently, the optical sensor chip 14 will retrieve a drifting or blurred image, leading to incorrect recognition of the image.

As molds used by various manufacturers for producing the separate optical parts have non-uniform specifications, problems such as varied height of the mouse base plates, poor close-fit and poor fixation effect among individual components often arise. Consequently, the resulting mice tend to become loose in the Z-axis direction during operation, thereby causing shifting and out-of-focus of the light path. As an effort to improve these problems caused by a loose part(s), attempts have been made to combine individual optical components into an assembly by various means. As shown in FIG. 3, by use of a fixture 28, an optical lens 26 and a PCB 22 having an optical sensor chip 20 and a light source device 24 soldered thereon are assembled tightly together to form an assembly 32, which is then placed into a recess 305 on a base plate 30 to complete the assembling process. Alternatively, as shown in FIG. 4, optical components such as a PCB, an optical sensor unit, a light source device, an optical lens or the like are packaged into an enclosed optical module 42, which is then placed into a recess 445 on a base plate 44 to complete the assembling process.

Although the optical mice shown in FIGS. 3 and 4 have most of the optical components fixed more properly and stably, engagement of the parts with the respective base plates is still accomplished by being simply placed therein. Moreover, to surely avoid that the recess 305 or 445 is too small to receive the assembly 32 or optical module 42, manufacturers will necessarily produce the recess 305 or 445 on the base plate 30 or 44 to be slightly larger, so that the optical mice shown in FIGS. 3 and 4 still suffer from the problem of loose engagement or misalignment between the assembly or module and the base plate.

### SUMMARY OF THE INVENTION

An object of the present invention is to improve the light path shifting of optical mice.

According to the present invention, an optical mouse includes a base plate having an engagement mechanism, and an assembly formed by fixing a printed circuit board (PCB) having a light source device and an optical sensor chip soldered thereon and an optical lens together by a fixture. The assembly has a corresponding structure to engage the engagement mechanism to absolutely fix the assembly onto the base plate.

According to the present invention, an optical mouse includes a base plate having an engagement mechanism, and an optical module having a light source device, an optical sensor chip, an optical lens and the like optical components. The optical module has a corresponding structure to engage the engagement mechanism to absolutely fix the optical module onto the base plate.

In an embodiment, the engagement mechanism includes a detent, a tenon, a slideway, a nut fixing post, a screw mount, a mounting tank, a mounting post or the like. The corresponding structure includes a groove, a concave hole, an opening, a flange plate, a support plate or the like.

In one embodiment, the assembly or the optical module is adhered to the base plate by applying an adhesive.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 is an exploded view of a conventional optical mouse;

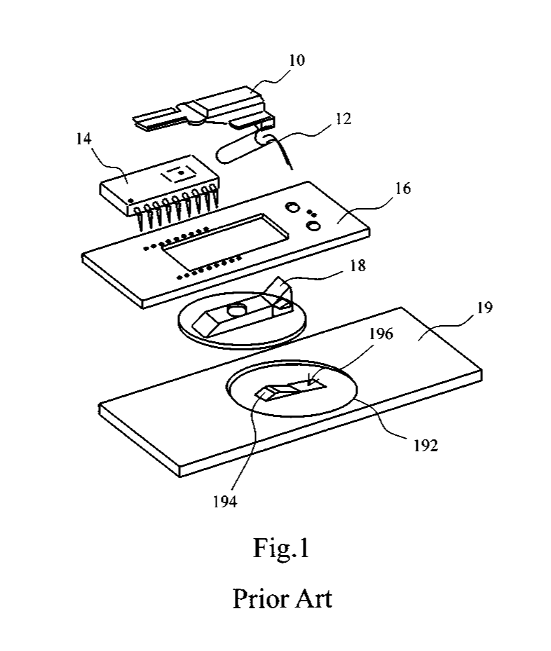

FIG. 2 is a side view of the optical mouse shown in FIG. 1;

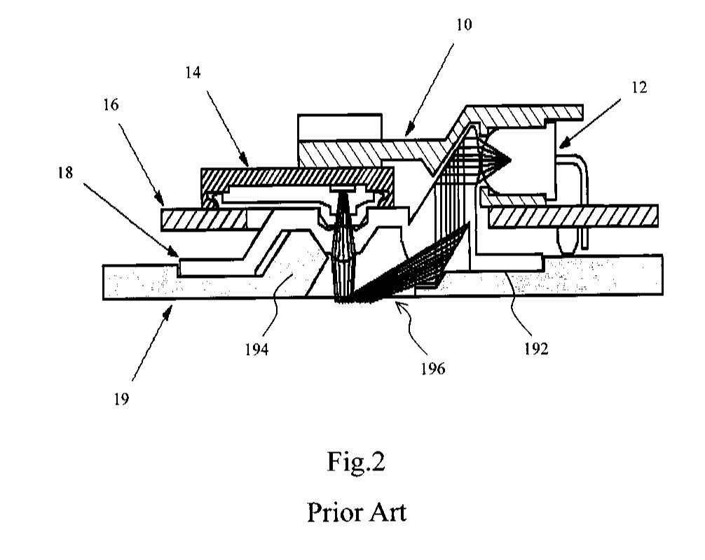

FIG. 3 is a schematic view illustrating how a conventional optical mouse is assembled;

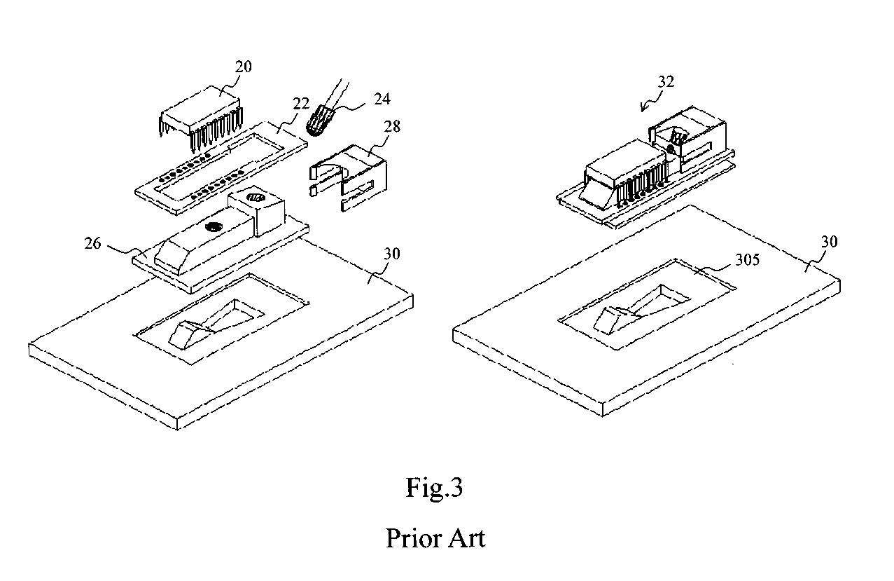

FIG. 4 is a schematic view illustrating how another conventional optical mouse is assembled;

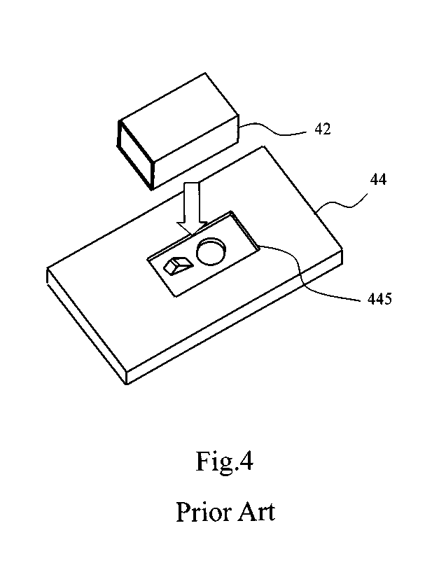

FIG. 5 is a schematic view of a first embodiment according to the present invention;

FIG. 6 is a schematic view of a second embodiment according to the present invention;

FIG. 7 is a schematic view of a third embodiment according to the present invention;

FIG. 8 is a schematic view of a fourth embodiment according to the present invention;

FIG. 9 is a schematic view of a fifth embodiment according to the present invention;

FIG. 10 is a schematic view of a sixth embodiment according to the present invention;

FIG. 11 is a schematic view of a seventh embodiment according to the present invention;

FIG. 12 is a schematic view of an eighth embodiment according to the present invention;

FIG. 13 is a schematic view of a ninth embodiment according to the present invention;

FIG. 14 is a schematic view of a tenth embodiment according to the present invention;

FIG. 15 is a schematic view of an eleventh embodiment according to the present invention;

FIG. 16 is a schematic view of a twelfth embodiment according to the present invention;

FIG. 17 is a schematic view of a thirteenth embodiment according to the present invention;

FIG. 18 is a schematic view of a fourteenth embodiment according to the present invention;

FIG. 19 is a schematic view of a fifteenth embodiment according to the present invention;

FIG. 20 is a schematic view of a sixteenth embodiment according to the present invention;

FIG. 21 is a schematic view of a seventeenth embodiment according to the present invention;

FIG. 22 is a schematic view of an eighteenth embodiment according to the present invention;

FIG. 23 is a schematic view of a nineteenth embodiment according to the present invention;

FIG. 24 is a schematic view of a twentieth embodiment according to the present invention;

FIG. 25 is a schematic view of a twenty-first embodiment according to the present invention;

FIG. 26 is a schematic view of a twenty-second embodiment according to the present invention;

FIG. 27 is a schematic view of a twenty-third embodiment according to the present invention;

FIG. 28 is a schematic view of a twenty-fourth embodiment according to the present invention;

FIG. 29 is a schematic view of a twenty-fifth embodiment according to the present invention; and

FIG. 30 is a schematic view of a twenty-sixth embodiment according to the present invention.

### DETAILED DESCRIPTION OF THE INVENTION

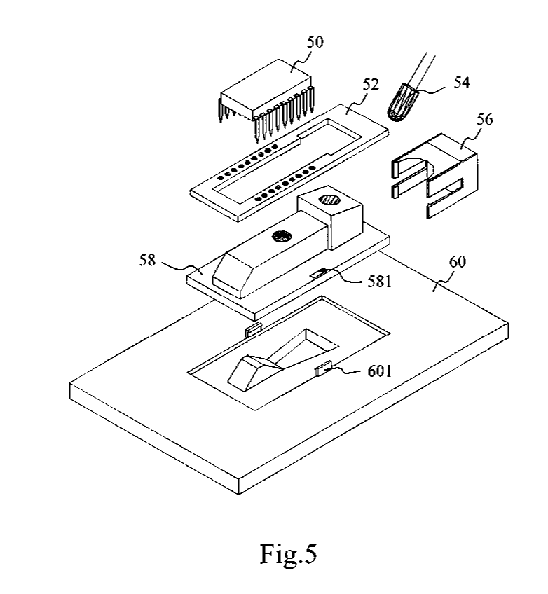

FIG. 5 is a schematic view of a first embodiment according to the present invention, in which after an optical sensor chip 50 and a light source device 54 are soldered onto a PCB 52, the PCB 52 is assembled with an optical lens 58 by means of a fixture 56 to form an assembly. A base plate 60 has a pair of detents 601 thereon, and the optical lens 58 has grooves 581 corresponding to the detents 601. During assembly, the detents 601 engage with the grooves 581 respectively so that the base plate 60 and the assembly including the optical lens 58, the PCB 52 and the fixture 56 are absolutely fixed together.

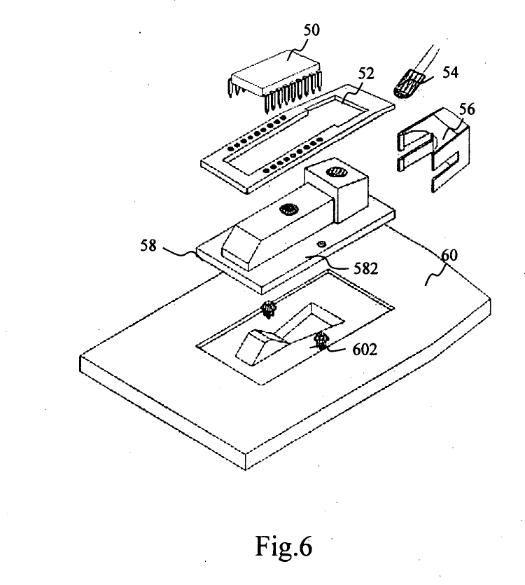

FIG. 6 is a schematic view of a second embodiment according to the present invention, in which a base plate 60 has two tenons 602, and an optical lens 58 has grooves 582 corresponding to the tenons 602. During assembly, the grooves 582 in the assembly including the optical lens 58, the PCB 52 and the like engage with the tenons 602 on the base plate 60 to absolutely fix the assembly and the base plate 60 together.

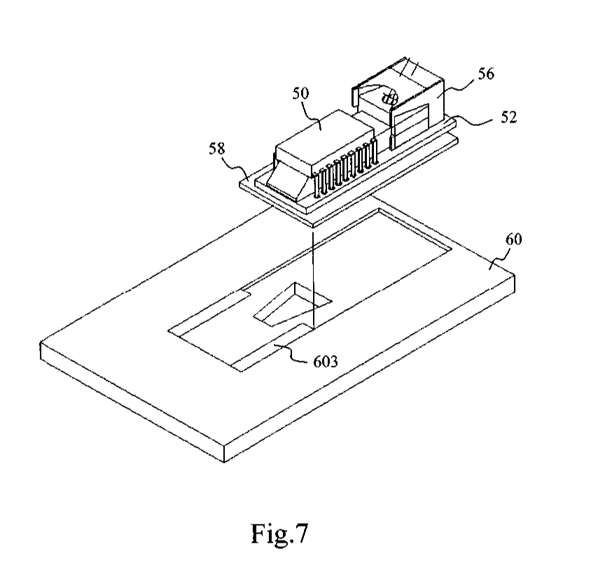

FIG. 7 is a schematic view of a third embodiment according to the present invention, in which a PCB 52 having an optical sensor chip 50 and a light source device (not shown) soldered thereon is assembled with an optical lens 58 by means of a fixture 56 to form an assembly. The base plate 60 has a slideway 603 for outer edges of the optical lens 58 to slide therein, thereby absolutely fixing the assembly and the base plate 60 together.

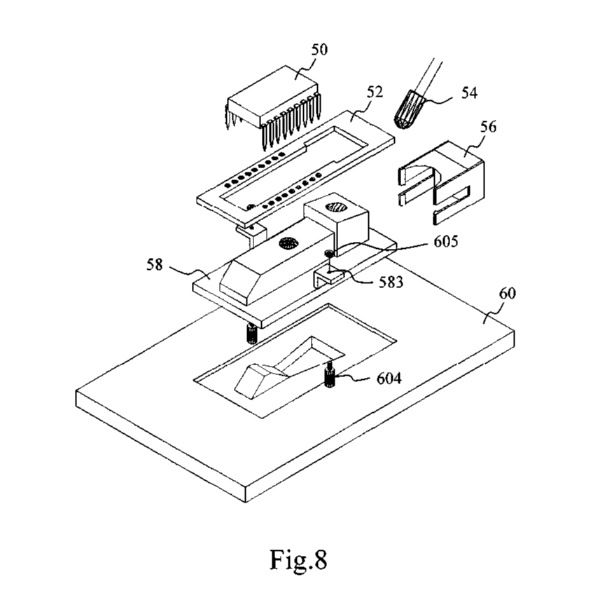

FIG. 8 is a schematic view of a fourth embodiment according to the present invention, in which a base plate 60 has nut fixing posts 604, and an optical lens 58 has openings 583 for the nut fixing posts 604 to be inserted there through respectively. During assembly, nuts 605 are used to lock the optical lens 58 to the nut fixing posts 604 on the base plate 60, thereby absolutely fixing the assembly and the base plate 60 together.

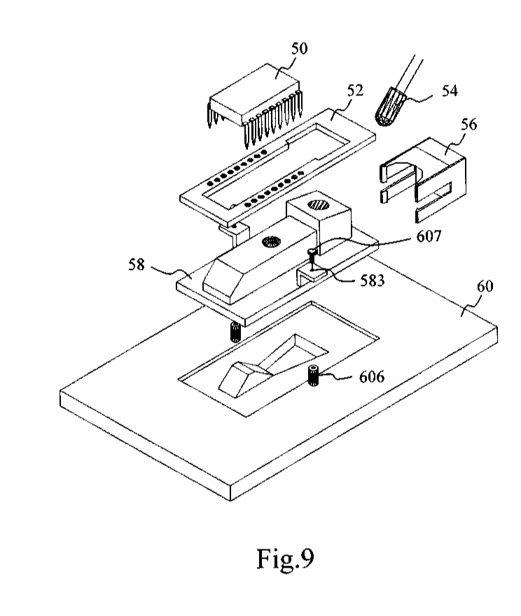

FIG. 9 is a schematic view of a fifth embodiment according to the present invention, in which a base plate 60 has screw mounts 606 so that screws 607 are threaded through openings 583 of an optical lens 58 into the screw mounts 606 to absolutely fix the assembly and the base plate 60 together.

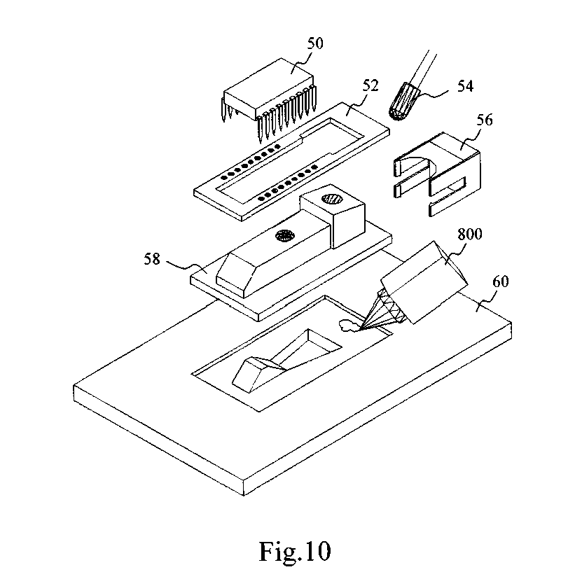

FIG. 10 is a schematic view of a sixth embodiment according to the present invention, in which by using a dispenser 800 to dispense an adhesive on a surface beneath the optical lens 58, the optical lens 58 is adhered to the base plate 60 to absolutely fix the assembly and the base plate 60 together.

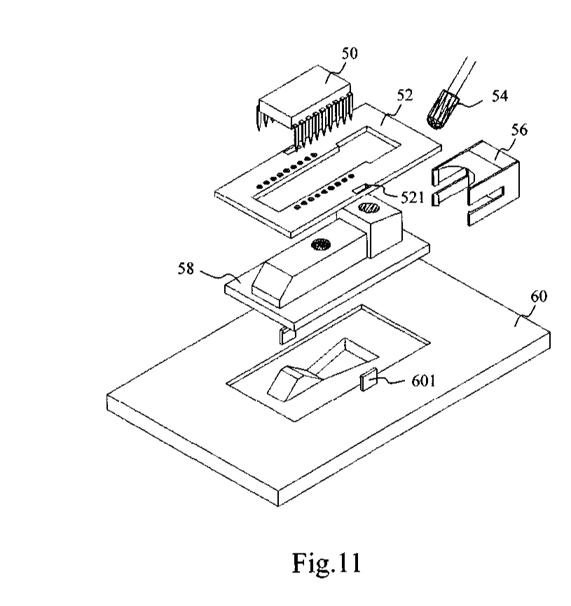

FIG. 11 is a schematic view of a seventh embodiment according to the present invention, in which grooves 521 are disposed on a PCB 52 for detents 601 on a base plate 60 to engage with.

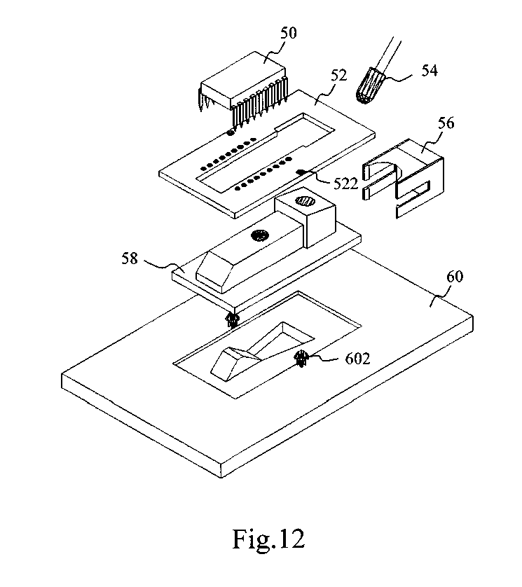

FIG. 12 is a schematic view of an eighth embodiment according to the present invention, in which a PCB 52 has concave holes 522 to engage with tenons 602 on a base plate 60.

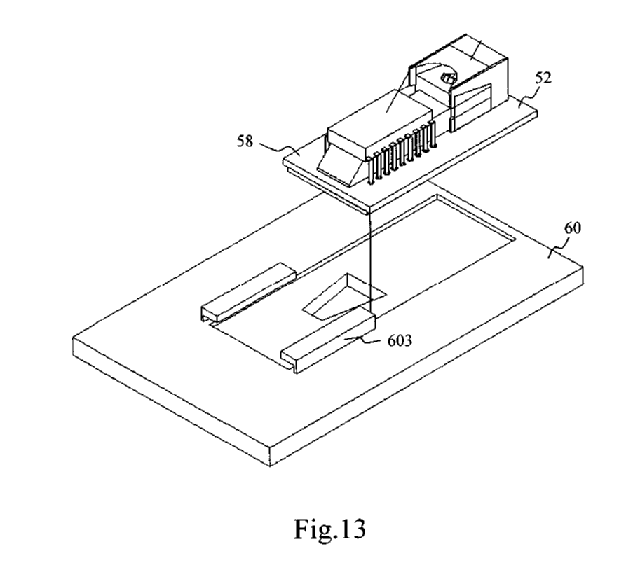

FIG. 13 is a schematic view of a ninth embodiment according to the present invention, in which a base plate 60 has slideways 603 for outer edges of a PCB 52 to slide therein, thereby absolutely fixing the assembly and the base plate 60 together.

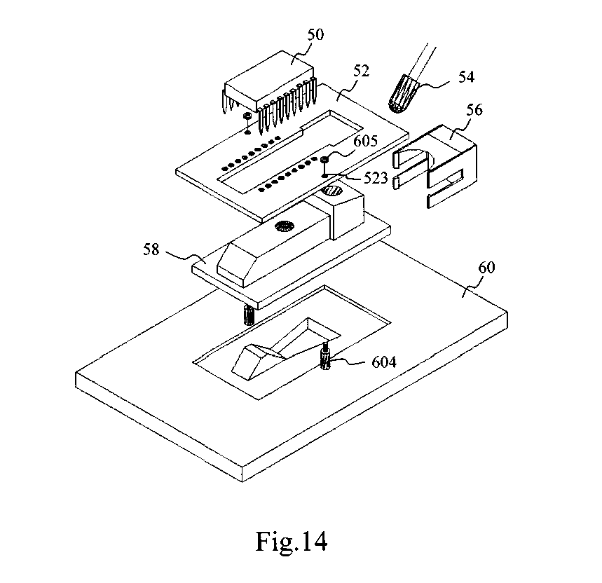

FIG. 14 is a schematic view of a tenth embodiment according to the present invention, in which a PCB 52 has openings 523 so that nuts 605 can be inserted therein to lock the PCB 52 to nut fixing posts 604 on a base plate 60, thereby absolutely fixing the assembly and the base plate 60 together.

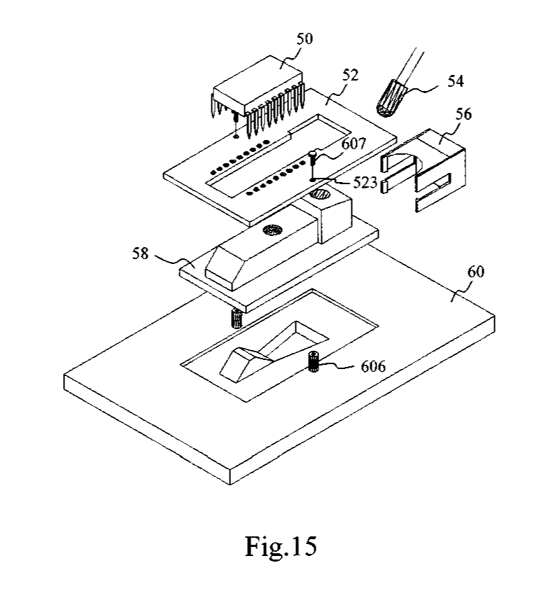

FIG. 15 is a schematic view of an eleventh embodiment according to the present invention, in which a base plate 60 has screw mounts 606 so that screws 607 are threaded through openings 523 into the screw mounts 606 to absolutely fix the assembly and the base plate 60 together.

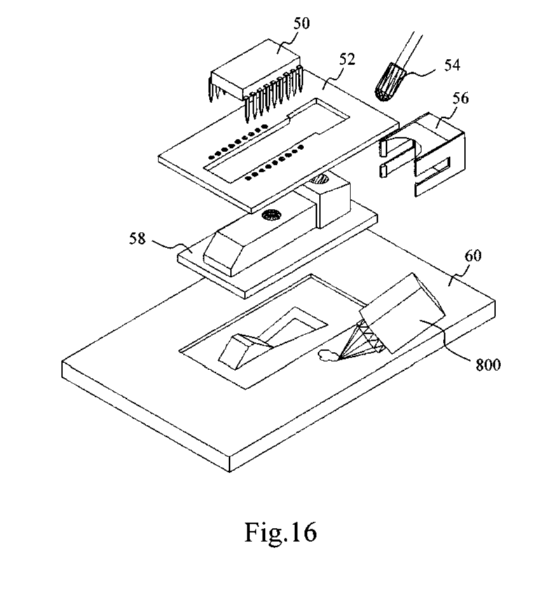

FIG. 16 is a schematic view of a twelfth embodiment according to the present invention, in which a PCB 52 is designed to be much wider, and by using a dispenser 800 to dispense an adhesive onto a base plate 60, the PCB 52 is adhered to the base plate 60, thereby absolutely fixing the assembly and the base plate 60 together.

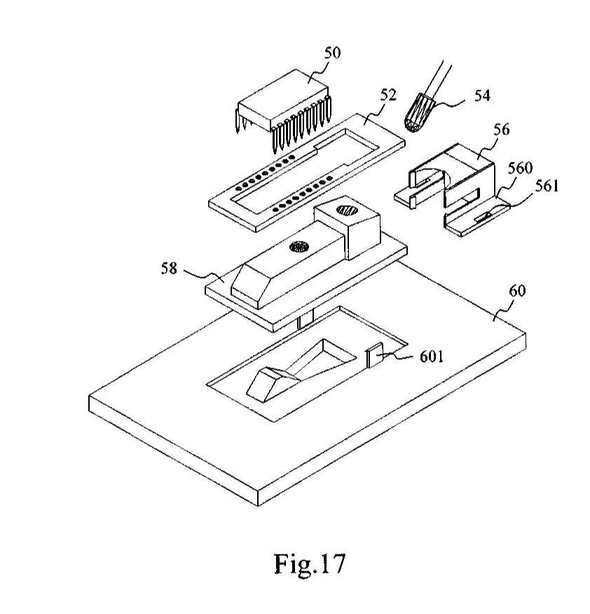

FIG. 17 is a schematic view of a thirteenth embodiment according to the present invention, in which two sides of a fixture 56 are extended beyond a support plates 560, so that grooves 561 can be formed thereon to engage with detents 601 on a base plate 60 to absolutely fix the assembly and the base plate 60 together.

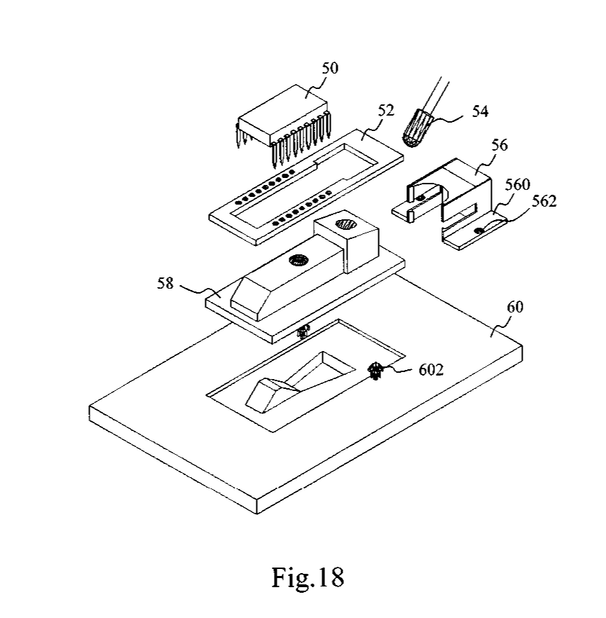

FIG. 18 is a schematic view of a fourteenth embodiment according to the present invention, in which concave holes 562 are formed on support plates 560 extended outwards from both sides of a fixture 56 to engage with tenons 602 on a base plate 60.

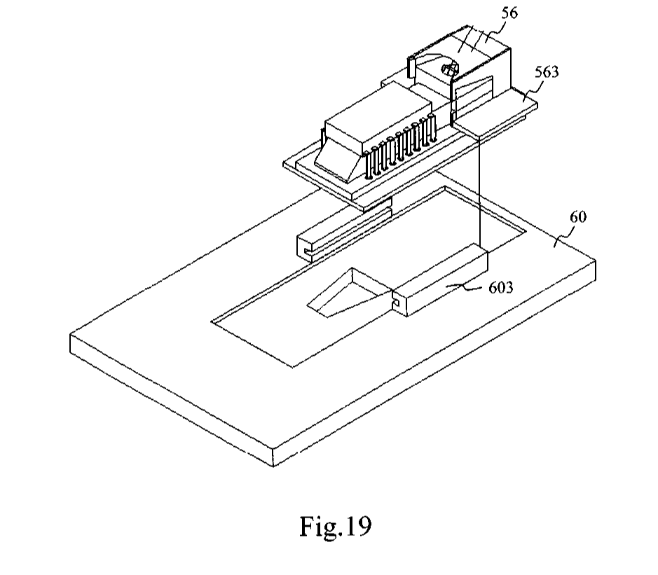

FIG. 19 is a schematic view of a fifteenth embodiment according to the present invention, in which a fixture 56 has flange plates 563 extended outwards from both sides thereof to engage with slideways 603 on a base plate 60, thereby absolutely fixing the assembly and the base plate 60 together.

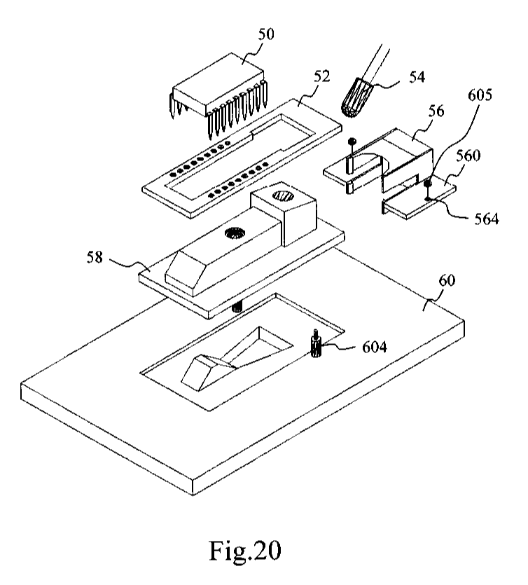

FIG. 20 is a schematic view of a sixteenth embodiment according to the present invention, in which support plates 560 at both sides of a fixture 56 have openings 564 respectively, so that nuts 605 can be locked to nut fixing posts 604 on a base plate 60 through the openings 564, thereby absolutely fixing the assembly and the base plate 60 together.

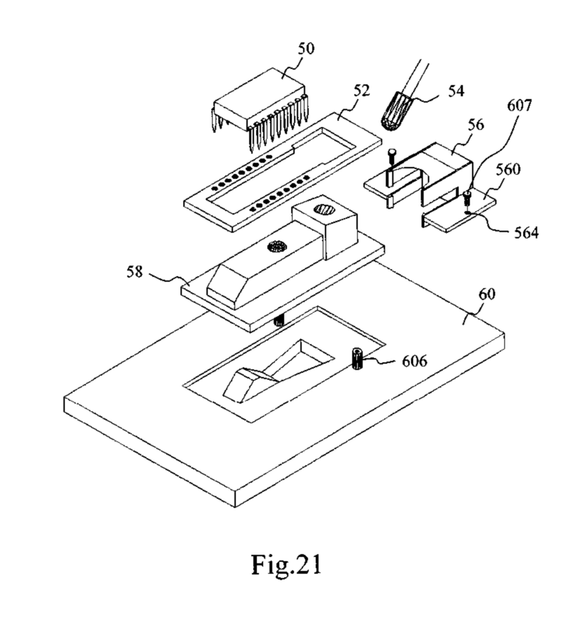

FIG. 21 is a schematic view of a seventeenth embodiment according to the present invention, in which a base plate 60 has screw mounts 606 so that screws 607 are locked through openings 564 of support plates 560 at both sides of a fixture 56 into the screw mounts 606 to absolutely fix the assembly and the base plate 60 together.

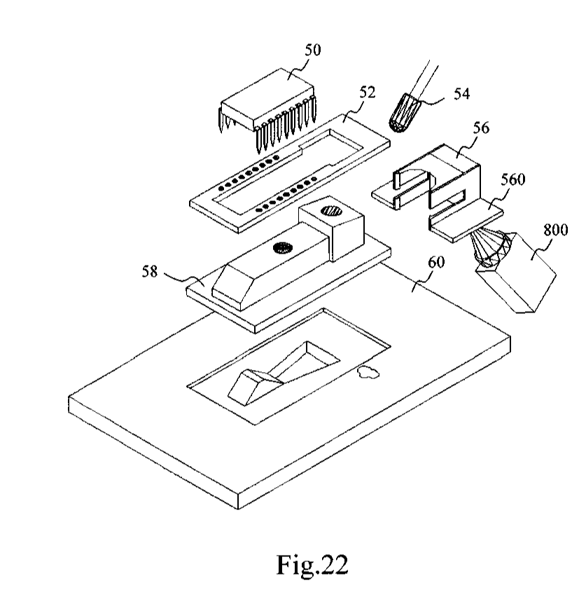

FIG. 22 is a schematic view of an eighteenth embodiment according to the present invention, in which by using a dispenser 800 to dispense an adhesive onto a bottom surface of support plates 560 at both sides of a fixture 56 or a base plate 60 to form a layer of adhesive between the base plate 60 and the support plates 560, the fixture 56 is adhered to the base plate 60, thereby absolutely fixing the assembly and the base plate 60 together.

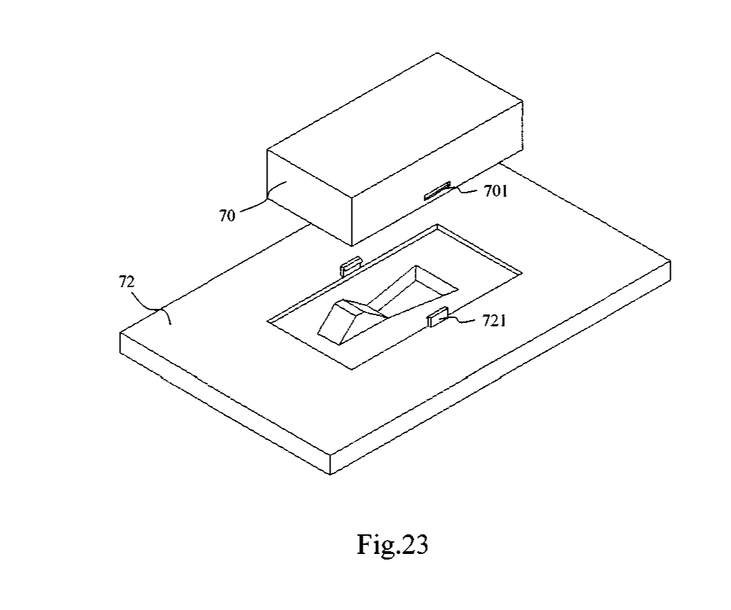

FIG. 23 is a schematic view of a nineteenth embodiment according to the present invention, in which an optical module 70 includes a PCB, an optical sensor unit, a light source device, an optical lens and the like optical components. On an enclosure of the optical module 70 are formed grooves 701 corresponding to detents 721 so that when the optical module 70 and a base plate 72 are assembled together, the detents 721 engage with the grooves 701 to absolutely fix the optical module 70 to the base plate 72.

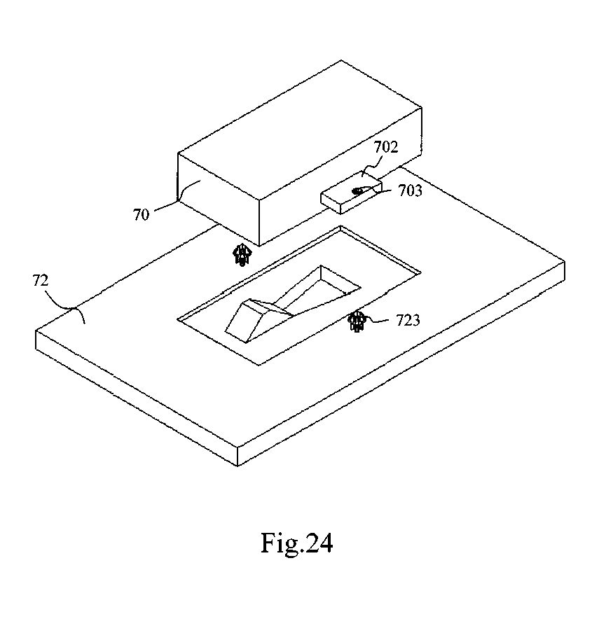

FIG. 24 is a schematic view of a twentieth embodiment according to the present invention, in which an optical module 70 has support plates 702 at both sides thereof, and the support plates 702 have concave holes 703, respectively, to engage with tenons 723 on a base plate 72 to absolutely fix the optical module 70 to the base plate 72.

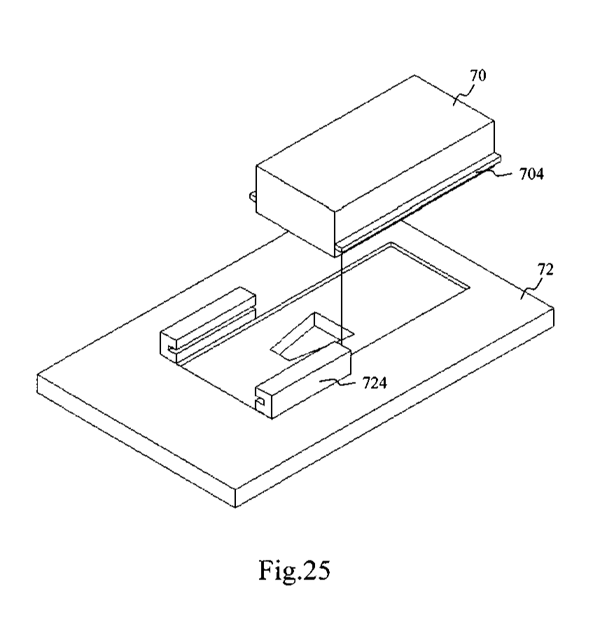

FIG. 25 is a schematic view of a twenty-first embodiment according to the present invention, in which an optical module 70 has flange plates 704 at both sides thereof for slideways 724 on a base plate 72 to slide therein and engage therewith, thereby absolutely fixing the optical module 70 and the base plate 72 together.

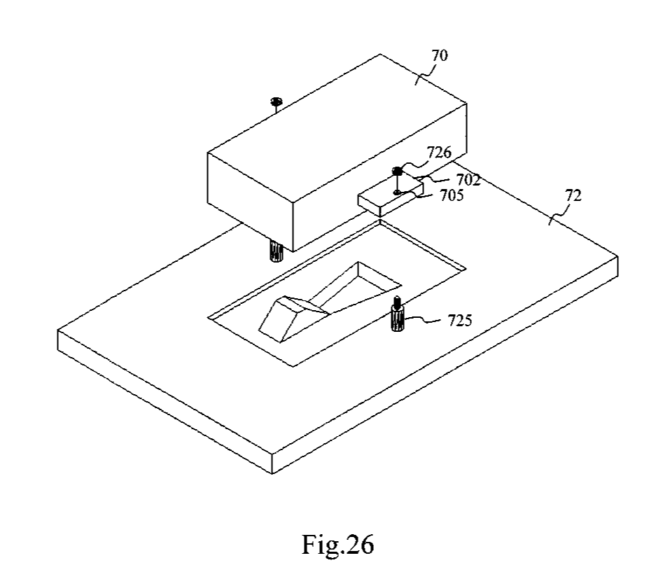

FIG. 26 is a schematic view of a twenty-second embodiment according to the present invention, in which an optical module 70 has support plates 702 at both sides thereof, openings 705 in the support plates 702 encircle nut fixing posts 725 on a base plate 72, and nuts 726 are locked to the nut locking post 725, thereby absolutely fixing the optical module 70 and the base plate 72 together.

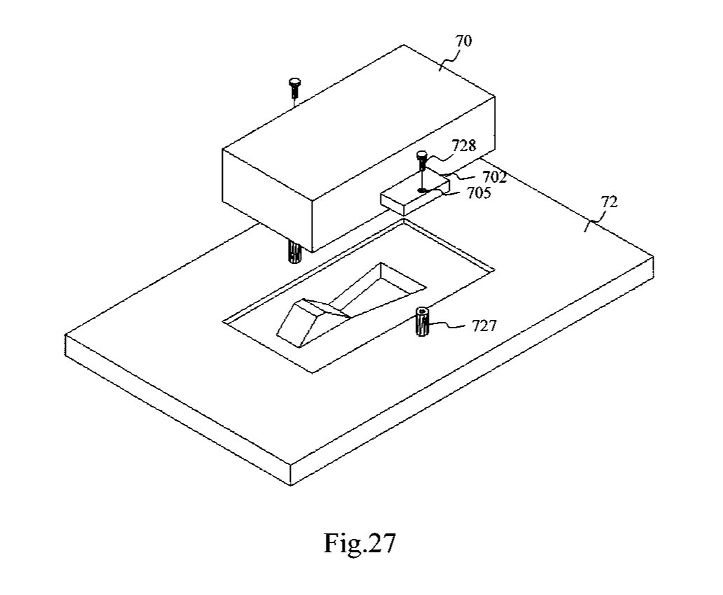

FIG. 27 is a schematic view of a twenty-third embodiment according to the present invention, in which screws 728 are locked to screw mounts 727 through openings 705 in support plates 702 at both sides of an optical module 70, thereby absolutely fixing the optical module 70 and a base plate 72 together.

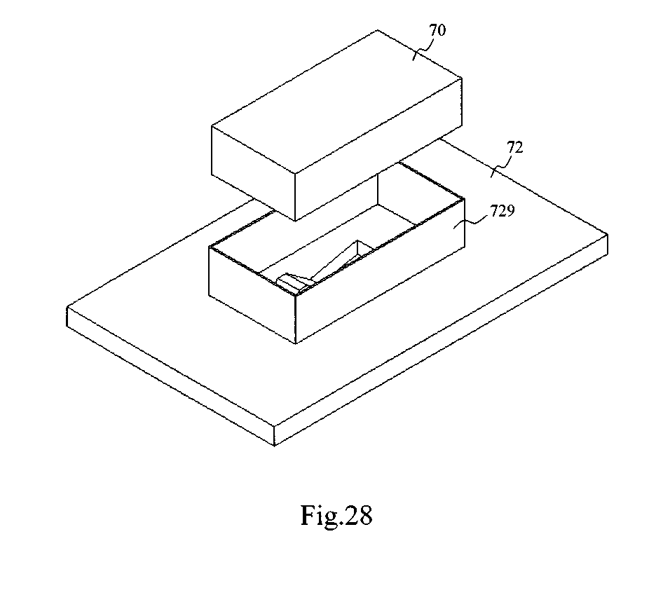

FIG. 28 is a schematic view of a twenty-fourth embodiment according to the present invention, in which a base plate 72 has a mounting tank 729 for mounting an optical module 70, and the dimensions and profile of the mounting tank 729 are designed in such a way that the optical module 70 and the base plate 72 are absolutely fixed together.

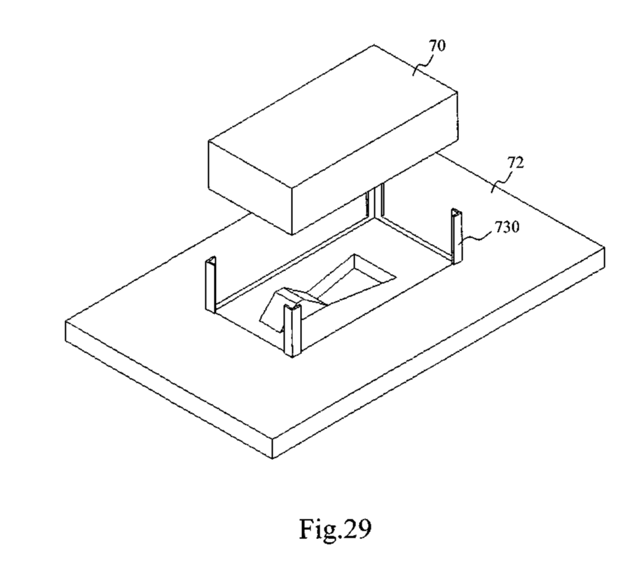

FIG. 29 is a schematic view of a twenty-fifth embodiment according to the present invention, in which a base plate 72 has four mounting posts 730 thereon to install an optical module 70, thereby absolutely fixing the optical module 70 and the base plate 72 together.

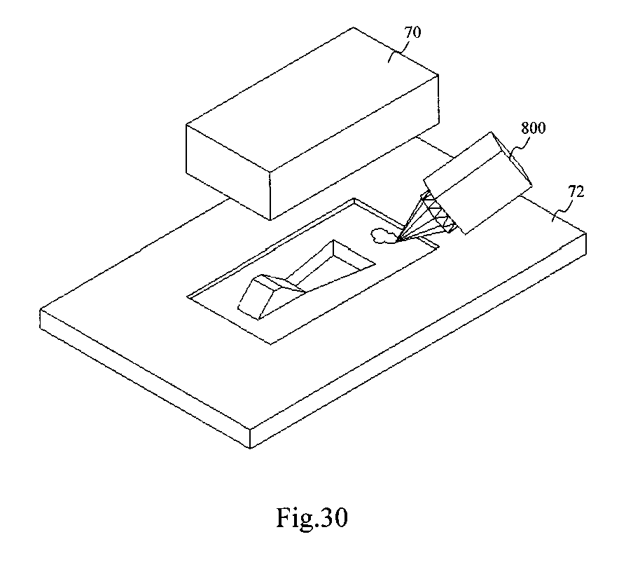

FIG. 30 is a schematic view of a twenty-sixth embodiment according to the present invention, in which by using a dispenser 800 to dispense an adhesive onto a base plate 72, an optical module 70 is adhered to the base plate 72.

In addition to the fixation structure combination conventionally provided by recesses and fool-proof devices, an optical mouse according to the present invention further provides a mechanism for absolute fixation between an optical module or assembly and a base plate. In other embodiments, an optical module or assembly and a base plate may be joined together by various means so long as the optical module or assembly and the base plate are absolutely fixed together to ensure a correct light path of the optical mouse.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. An optical mouse, comprising:
a base plate having an engagement mechanism; and
an assembly including a printed circuit board having a light source device and an optical sensor chip soldered thereon and an optical lens fixed together, and a corresponding structure for the engagement mechanism to engage with to absolutely fix the assembly to the base plate.

2. The optical mouse of claim 1, further comprising a light source mount for stabling the light source device.

3. The optical mouse of claim 1, wherein the light source device is a light emitting diode.

4. The optical mouse of claim 1, wherein the engagement mechanism includes a detent.

5. The optical mouse of claim 4, wherein the corresponding structure includes a groove to be engaged with the detent.

6. The optical mouse of claim 1, wherein the engagement mechanism includes a tenon.

7. The optical mouse of claim 6, wherein the corresponding structure includes a concave hole to be engaged with the tenon.

8. The optical mouse of claim 1, wherein the engagement mechanism includes a slideway.

9. The optical mouse of claim 8, wherein the corresponding structure includes a flange plate to engage with the slideway.

10. The optical mouse of claim 1, wherein the engagement mechanism includes a screw mount or nut fixing post.

11. The optical mouse of claim 10, wherein the corresponding structure includes an opening to be engaged with the screw mount or nut fixing post.

12. The optical mouse of claim 1, wherein the corresponding structure is disposed on the printed circuit board or optical lens.

13. The optical mouse of claim 1, wherein the assembly includes a fixture to combine the printed circuit board and optical lens together.

14. The optical mouse of claim 13, wherein the corresponding structure is disposed on the fixture.

15. The optical mouse of claim 14, wherein the fixture comprises a support plate for the corresponding structure to be disposed thereon.

16. An optical mouse, comprising:
a base plate having an engagement mechanism; and
an optical module having a corresponding structure for the engagement mechanism to engage with to absolutely fix the optical module to the base plate.

17. The optical mouse of claim 16, wherein the optical module comprises:
a printed circuit board;
a light source device soldered on the printed circuit board;
an optical sensor chip soldered on the printed circuit board; and
an optical lens in a light path to be established from the light source device to the optical sensor chip.

18. The optical mouse of claim 16, wherein the engagement mechanism includes a detent.

19. The optical mouse of claim 18, wherein the corresponding structure includes a groove to be engaged with the detent.

20. The optical mouse of claim 16, wherein the engagement mechanism includes a tenon.

21. The optical mouse of claim 20, wherein the corresponding structure includes a concave hole to be engaged with the tenon.

22. The optical mouse of claim 16, wherein the engagement mechanism includes a slideway.

23. The optical mouse of claim 22, wherein the corresponding structure includes a flange plate to engage with the slideway.

24. The optical mouse of claim 16, wherein the engagement mechanism includes a screw mount or nut fixing post.

25. The optical mouse of claim 24, wherein the corresponding structure includes an opening to be engaged with the screw mount or nut fixing post.

26. The optical mouse of claim 16, wherein the engagement mechanism includes a mounting tank for mounting the optical module.

27. The optical mouse of claim 16, wherein the engagement mechanism includes a mounting post for mounting the optical module.

28. The optical mouse of claim 16, wherein the optical module comprises a support plate for the corresponding structure to be disposed thereon.

29. An optical mouse, comprising:
a base plate;
an assembly including a printed circuit board having a light source device and an optical sensor chip soldered thereon and an optical lens fixed together; and
an adhesive between the base plate and assembly to absolutely fix the assembly to the base plate.

30. An optical mouse, comprising:
a base plate;
an optical module; and
an adhesive between the base plate and optical module to absolutely fix the optical module to the base plate.
